(19) United States
(12) Patent Application Publication
(10) Pub. No.: US 2022/0363886 A1
(43) Pub. Date: Nov. 17, 2022

(54) COMBINATION OF A THERMOPLASTIC ELASTOMER AND A FLUOROPOLYMER

(71) Applicant: Arkema France, Colombes (FR)

(72) Inventors: Florent ABGRALL, Serquigny (FR); Samuel DEVISME, Serquigny (FR); Anthony BONNET, Colombes Cedex (FR); Quentin PINEAU, Serquigny (FR)

(21) Appl. No.: 17/618,923

(22) PCT Filed: Jun. 23, 2020
(86) PCT No.: PCT/FR2020/051093

§ 371 Date: Dec. 14, 2021

(30) Foreign Application Priority Data
Jun. 27, 2019 (FR) 1907041

(51) Int. Cl. C08L 27/16

(52) U.S. Cl. CPC C08L 27/16; C08L 2203/16; C08L 2207/04

(57) ABSTRACT

The present invention relates to a combination of polymers comprising:
at least one thermoplastic elastomer comprising at least 10% by mass of ester flexible blocks relative to the total mass of the thermoplastic elastomer, and
at least one fluoropolymer comprising a vinylidene fluoride homopolymer or copolymer.

### FIELD OF THE INVENTION

The present invention relates to a combination of at least one fluoropolymer with at least one thermoplastic elastomer.

### TECHNICAL BACKGROUND

Thermoplastic elastomers (TPE) are polymers in full development in many sectors such as motor vehicles, architecture, construction, electronics and the food industry. This commercial success is notably linked to their great flexibility and elasticity, and also to their simplified implementation when compared with rubbers, which also have great flexibility.

The reason for this is that the implementation of thermoplastic elastomers requires fewer steps than that of rubbers. Thus, the manufacturing time for thermoplastic elastomers is shorter. Furthermore, by means of the numerous possible transformation techniques, the shape of the components that can be obtained with thermoplastic elastomers is very varied, unlike conventional rubbers which cannot be blow-moulded or thermoformed, for example.

Moreover, thermoplastic elastomers have the additional advantage of not being vulcanized, unlike rubbers, which means that their manufacturing waste can be easily recycled.

However, thermoplastic elastomers suffer from low chemical inertness and from limited resistance to soiling, which restricts the application of these compounds notably in the pharmaceutical, food, household electrical appliance and consumer goods fields.

Fluoro elastomers (FKM), such as copolymers of vinylidene fluoride and of hexafluoropropylene, have improved chemical resistance properties when compared with thermoplastic elastomers. However, their implementation is complex. Specifically, these compounds are in the form of blocks, which first need to be calendered before transforming them by pressing into the desired form. In addition, a crosslinking process must be applied; this process is initiated during pressing but then requires annealing to arrive at completion. This process is thus long and expensive and entails substantial losses that cannot be recycled.

Consequently, there is a need for thermoplastic composites, which are both flexible and elastic and which have improved chemical resistance and soiling resistance, which should be addressed.

### SUMMARY OF THE INVENTION

The present invention derives from the unexpected demonstration, by the inventors, that a combination of a thermoplastic elastomer and a statistical copolymer of vinylidene fluoride and of hexafluoropropylene leads to products which combine good flexibility and elasticity properties and which have great chemical resistance and soiling resistance.

Thus, the present invention relates to a combination of polymers comprising:

at least one thermoplastic elastomer comprising at least 10% by mass of ester flexible blocks relative to the total mass of the thermoplastic elastomer, and

at least one fluoropolymer, notably a vinylidene fluoride homopolymer or copolymer.

The present invention also relates to a composition comprising the combination as defined above.

The present invention also relates to an article formed from the combination as defined above or from the composition as defined above.

### DETAILED DESCRIPTION OF THE INVENTION

### Definition

The elongation at break or percentage elongation is a dimensionless characteristic of materials. It defines the capacity of a material to become elongated before breaking when it is placed under tensile stress. The elongation at break is determined by means of a tensile test according to the standard ISO 527 1A.

The plastic shrinkage is the ability of a body to regain its normal state after a temperature rise and/or a plastic deformation. The term shrinkage more particularly denotes the processes which lead to a reduction in the dimensions of a moulded component during its forming (denoted by the term “immediate shrinkage”) and after its forming (“delayed shrinkage”). In the case of moulding, the plastic shrinkage may be defined as the percentage (%) difference between the dimensions of the final component and the dimensions of the mould.

### Fluoropolymer

The fluoropolymer according to the invention is a thermoplastic polymer. It is a vinylidene fluoride (VDF, CH2=CF2) homopolymer or a copolymer prepared by copolymerization of vinylidene fluoride with a fluoro comonomer chosen from: vinyl fluoride; trifluoroethylene (VF3); chlorotrifluoroethylene (CTFE); 1,2-difluoroethylene; tetrafluoroethylene (TFE); hexafluoropropylene (HFP); perfluoro(alkyl vinyl) ethers such as perfluoro(methyl vinyl) ether (PMVE), perfluoro(ethyl vinyl) ether (PEVE) and perfluoro(propyl vinyl) ether (PPVE); perfluoro(1,3-dioxole); and perfluoro(2,2-dimethyl-1,3-dioxole) (PDD).

Preferably, the fluoro comonomer is chosen from chlorotrifluoroethylene (CTFE), hexafluoropropylene (HFP), trifluoroethylene (VF3) and tetrafluoroethylene (TFE), and mixtures thereof.

The comonomer is advantageously HFP. Preferably, the copolymer comprises only VDF and HFP.

Preferably, the fluoro copolymers are VDF copolymers, in particular VDF-HFP.

Preferably, the VDF copolymer, in particular the VDF-HFP copolymer, is a statistical copolymer.

According to one embodiment, the fluoropolymer according to the invention has a melting point of less than 170° C., preferably less than or equal to 150° C.

### Thermoplastic Elastomer

The thermoplastic elastomer according to the invention is a block copolymer.

According to the invention, the term “block copolymer” means thermoplastic elastomer (TPE) polymers, which comprise, in alternance, “hard” or “rigid” blocks or segments and “supple” or “flexible” blocks or segments.

The flexible block of the thermoplastic elastomer according to the invention may be composed of ether, ester, polyester, polyether and polybutadiene blocks. Preferably, the flexible block of the thermoplastic elastomer according to the invention is partially or totally composed of polyester flexible blocks.

For the purposes of the invention, the term “polyester blocks” means polyesters usually manufactured by polycondensation between at least one dicarboxylic acid and at least one diol, or by lactone ring-opening polymerization.

As examples of dicarboxylic acids according to the invention, mention may be made of butanedioic acid, adipic acid, methyladipic acid, succinic acid, suberic acid, azelaic acid, sebacic acid, oxalic acid, glutaric acid, pimelic acid, phthalic acid, terephthalic acid, isophthalic acid, dodecanedicarboxylic acid, myristic acid, tetradecanedicarboxylic acid, hexadecanedicarboxylic acid, octadecanedicarboxylic acid and mixtures thereof, and dimerized fatty acids. Preferably, the dimerized fatty acids according to the invention are obtained by polymerization of monounsaturated and polyunsaturated fatty acids or mixtures thereof, optionally in the presence of a catalyst, such as a bentonite or montmorillonite clay. Preferably, the dimerized fatty acids according to the invention are obtained by polymerization of monounsaturated and polyunsaturated fatty acids containing between 6 and 22 carbon atoms. As examples of fatty acids used for forming the dimerized fatty acids according to the invention, mention may be made of oleic acid, linoleic acid and ricinoleic acid.

As examples of diols according to the invention, mention may be made of linear aliphatic diols such as ethylene glycol, 1,3-propylene glycol, 1,4-butylene glycol, diethylene glycol, 1,6-hexylene glycol, branched diols such as neopentyl glycol, 3-methylpentane glycol, 2,2-dimethylpropylene glycol, 1,2-propylene glycol, and cyclic diols such as 1,4-bis(hydroxymethyl)cyclohexane and 1,4-cyclohexanedimethanol, and mixtures thereof.

An example of a lactone according to the invention that may be mentioned is caprolactone.

As examples of polyester flexible blocks according to the invention, mention may be made of polybutyl adipate, polyglycol sebacate, poly(caprolactone), polymers based on fatty acid dimers and also the polyester blocks described, for example, in French patent application 0 950 637 from page 34 lines 16 to page 35 line 6.

Preferably, the thermoplastic elastomer according to the invention comprises at least 10%, at least 11%, at least 12%, at least 13%, at least 14%, at least 15% by mass of ester flexible blocks relative to the total mass of the thermoplastic elastomer. Advantageously, the thermoplastic elastomer according to the invention comprises at least 20%, at least 25%, at least 30%, at least 35%, at least 40%, at least 45%, at least 50% by mass of ester flexible blocks relative to the total mass of the thermoplastic elastomer.

The rigid block of the thermoplastic elastomer according to the invention may be composed of blocks that are well known to those skilled in the art. According to one embodiment, the rigid block of the thermoplastic elastomer according to the invention is selected from styrene segments, isocyanate segments, ester segments, polyester segments and amide segments.

According to one embodiment, the rigid block of the thermoplastic elastomer according to the invention does not comprise any urethane segments.

Preferably, the thermoplastic elastomer according to the invention is selected from the group consisting of polyester-based polyamide elastomers (TPE-A), also known as

Preferably, the polyester-based polyamide elastomer (TPE-A) according to the invention is a copolymer containing flexible blocks based on polyester and optionally on polyether and containing polyamide rigid blocks. More preferably, the TPE-A according to the invention is a copolymer containing polyester-based flexible blocks and polyamide rigid blocks.

The term “rigid blocks” in the TPE-As according to the invention means polyamide blocks, which may comprise polyamide or copolyamide blocks.

Preferably, the polyamide elastomer according to the invention comprises at least one polyamide block as defined in French patent application 0 950 637 from page 27 line 18 to page 31 line 14. As examples of polyamide blocks according to the invention, mention may be made of polyamide blocks based on PA12, PA11, PA10.10, PA6.10, PA6, PA6/12, PA 4.4, PA 4.6, PA 4.9, PA 4.10, PA 4.12, PA 4.13, PA 4.14, PA 4.16, PA 4.18, PA 4.36, PA 5.4, PA 5.9, PA 5.10, PA 5.12, PA 5.13, PA 5.14, PA 5.16, PA 5.18, PA 5.36, PA 6.4, PA 6.6, PA 6.9, PA 6.12, PA 6.13, PA 6.14, PA 6.16, PA 6.18, PA 6.36, PA 9.4, PA 9.6, PA 9.10, PA 9.12, PA 9.13, PA 9.14, PA 9.16, PA 9.18, PA 9.36, PA 10.4, PA 10.6, PA 10.9, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36 and 12.T.

Preferably, the TPE-A according to the invention comprises at least one polyester flexible block. The polyester flexible blocks are preferably manufactured by polycondensation between a dicarboxylic acid and a diol, or by lactone ring-opening polymerization as described above.

Preferably, the polyester flexible blocks in the TPE-As according to the invention are selected from those mentioned above, in particular polybutyl adipate, polyglycol sebacate, poly(caprolactone), polymers based on fatty acid dimers and also the polyester blocks described, for example, in French patent application 0 950 637 from page 34 lines 16 to page 35 line 6.

The flexible block of the TPE-A according to the invention may also comprise polyether blocks. In this case, the polyether block according to the invention is as described, for example, in French patent application 0 950 637 from page 32 line 3 to page 33 line 26. As examples of polyether flexible blocks, mention may be made of poly(ethylene glycol) (PEG), poly(1,2-propylene glycol) (PPG), poly(1,3-propylene glycol) (PO3G), poly(tetramethylene glycol) (PTMG), and copolymers or mixtures thereof.

Preferably, the TPE-A according to the invention comprises at least 10%, at least 11%, at least 12%, at least 13%, at least 14%, at least 15% by mass of polyester flexible blocks relative to the total mass of the TPE-A. Advantageously, the TPE-A according to the invention comprises at least 20%, at least 25%, at least 30%, at least 35%, at least 40%, at least 45%, at least 50% by mass of polyester flexible blocks relative to the total mass of the TPE-A.

Preferably, PEBAs result from the polycondensation of polyamide blocks bearing reactive ends with polyether blocks bearing reactive ends, such as, inter alia:

1) polyamide blocks bearing diamine chain ends with polyoxyalkylene blocks bearing dicarboxylic chain ends;

2) polyamide blocks bearing dicarboxylic chain ends with polyoxyalkylene blocks bearing diamine chain ends, obtained by cyanoethylation and hydrogenation of α,ω-dihydroxylated aliphatic polyoxyalkylene blocks, known as polyetherdiols;

3) polyamide blocks bearing dicarboxylic chain ends with polyetherdiols, the products obtained being, in this particular case, polyetheresteramides.

Advantageously, the PEBA according to the invention comprises PA12-PEG, PA6-PEG, PA6/12-PEG, PA11-PEG, PA12-PTMG, PA6-PTMG, PA6/12-PTMG, PA11-PTMG, PA12-PEG/PPG, PA6-PEG/PPG, PA6/12-PEG/PPG and/or PA11-PEG/PPG.

As examples of polyamide elastomers according to the invention, mention may be made of the products sold by the company Arkema under the name Pebax®.

Preferably, the thermoplastic elastomer according to the invention is selected from the group consisting of copolyester elastomers (TPEE) and polyester-based polyamide elastomers (TPE-A). Preferably also, the thermoplastic elastomer according to the invention is not a polyester-based thermoplastic polyurethane (TPU).

Copolyester elastomers (TPEE) are copolymers containing polyester blocks and polyether blocks. They consist of flexible polyether blocks derived from polyetherdiols and of rigid polyester blocks which result from the reaction of at least one dicarboxylic acid with at least one chain-extending short diol unit. The polyester blocks and the polyether blocks are connected via ester bonds resulting from the reaction of the acid functions of the dicarboxylic acid with the OH functions of the polyetherdiol. The sequence of polyethers and of diacids forms the flexible blocks whereas the sequence of glycol or of butanediol with diacids forms the rigid blocks of the copolyetherester. The chain-extending short diol may be chosen from the group consisting of neopentyl glycol, cyclohexanedimethanol and aliphatic glycols of formula HO(CH₂)nOH in which n is an integer ranging from 2 to 10.

Advantageously, the diacids are aromatic dicarboxylic acids containing from 8 to 14 carbon atoms. Up to 50 mol % of the aromatic dicarboxylic acid may be replaced with at least one other aromatic dicarboxylic acid containing from 8 to 14 carbon atoms, and/or up to 20 mol % may be replaced with an aliphatic dicarboxylic acid containing from 2 to 14 carbon atoms.

As examples of aromatic dicarboxylic acids, mention may be made of terephthalic acid, isophthalic acid, dibenzoic acid, naphthalenedicarboxylic acid, 4,4′-diphenylenedicarboxylic acid, bis(p-carboxyphenyl)methane acid, ethylenebis-p-benzoic acid, 1,4-tetramethylenebis(p-oxybenzoic acid), ethylenebis(p-oxybenzoic acid) and 1,3-trimethylenebis(p-oxybenzoic acid).

As examples of glycols, mention may be made of ethylene glycol, 1,3-trimethylene glycol, 1,4-tetramethylene glycol, 1,6-hexamethylene glycol, 1,3-propylene glycol, 1,8-octamethylene glycol, 1,10-decamethylene glycol and 1,4-cyclohexylenedimethanol. The copolymers containing polyester blocks and polyether blocks are, for example, copolymers containing polyether units derived from polyetherdiols such as polyethylene glycol (PEG), polypropylene glycol (PPG), polytrimethylene glycol (PO3G) or polytetramethylene glycol (PTMG), dicarboxylic acid units such as terephthalic acid and glycol (ethanediol) or 1,4-butanediol units. Such copolyetheresters are described in patents EP 402 883 and EP 405 227. These polyetheresters are thermoplastic elastomers. They may contain plasticizers.

### Combination

According to one embodiment of the combination according to the invention, the thermoplastic elastomer and the fluoropolymer are mixed in molten form.

The mixing may take place according to any technique that is well known to those skilled in the art. Preferably, the various components of the combination according to the invention are mixed in a mixer and melted by heating or irradiation.

Preferably, the temperature at which the mixing is performed is between 190 and 250° C.

According to another embodiment of the invention, the combination is in the form of at least one bilayer formed from a layer of the fluoropolymer on a layer of the thermoplastic elastomer according to the invention. The bilayer may be formed via any technique known to those skilled in the art. By way of example, the combination of layers may be formed by overmoulding, pressing, coating or coextrusion.

Preferably, the combination according to the invention comprises between 50% and 90%, more preferably between 60% and 80%, by mass of fluoropolymer relative to the total mass of the combination according to the invention.

Advantageously, the combination according to the invention has great flexibility and elasticity and also good chemical resistance.

### Additional Compound

The composition according to the invention may comprise one or more additives that are well known to those skilled in the art. As examples of additives, mention may be made of fillers, antioxidants, anti-pyrolysis agents, UV-absorbing agents, anti-hydrolysis agents, dyes, pigments, adhesive additives, bonding agents, antistatic agents, electrical conducting agents, plasticizers, anti-friction agents, lubricants, mould-release agents and flame retardants.

As examples of fillers, mention may be made of glass fibers or carbon fibers, aramid resins, talc, silica, kaolin, glass pearls and beads, ceramic, metallic fillers, metal salts and oxides, such as aluminium powder, calcium and manganese carbonates, ferrite powders or titanium dioxide.

Preferably, it is possible to incorporate up to 50% and preferably up to 40% by mass of fillers relative to the total weight of the composition according to the invention.

As examples of dyes and pigments, mention may be made of soluble dyes of organic nature such as monoazo or diazo dyes bearing —OH or —NH₂ groups, anthraquinone amines, nigrosin or induline bases; insoluble pigments such as oxides of titanium, lead, chromium, manganese, cobalt, cadmium and iron metal salts, coupled azo and diazo organic pigments; aniline black; and organic acid salts.

Preferably, the dyes and pigments are added in an amount ranging from 0.1% to 5% by mass relative to the total mass of the composition according to the invention.

As examples of antioxidants, mention may be made of aromatic amines such as phenylnaphthylamines; phenols, cresols, xylenols; and organic phosphites.

Preferably, the antioxidants are added in an amount ranging from 0.25% to 3% by mass relative to the total mass of the composition according to the invention.

As examples of flame retardants, mention may be made of phosphorus compounds such as phosphates, phosphites and phosphonates; halogenated compounds, such as chlorinated paraffins, chlorobenzene, tetrabromoethane; halophosphorus compounds; antimony compounds; boron compounds such as zinc borate; and aluminium hydrates.

As examples of lubricants and mould-release agents, mention may be made of metal stearates, stearamides, oleic and stearic derivatives, fatty acid esters, hydrocarbon waxes and fatty acids.

As examples of antistatic agents, mention may be made of amines, quaternary ammonium salts and organic phosphates.

As examples of plasticizers, mention may be made of phthalates, adipates, sebacates, epoxidized linseed and soybean oils, polyester plasticizers such as ethylene glycol polysuccinate, polyadipate or polysebacate; phosphates, glycols and derivatives thereof, fatty acid esters, organochlorine derivatives, and toluenesulfonic acid derivatives.

As adhesives, mention may be made of methyl methacrylate monomer, chlorohydrocarbons such as methylene chloride, glycol monochlorhyde, trichloroethylene, chloroform; ketones, and benzene-based hydrocarbons.

### Use

The combination according to the invention or the composition according to the invention may be used for manufacturing components of various forms such as moulded components, extruded components, films, sheets or multilayer articles.

By way of example, the combination or the composition according to the invention may be used in the form of a mixture obtained in molten form in the manufacture of an article by cast moulding, by injection moulding and by extrusion.

Also by way of example, the combination or the composition according to the invention may be used in the form of multilayer films of a layer of at least one fluoropolymer at the surface of a layer of at least one thermoplastic elastomer containing polyester blocks by overmoulding, pressing, coextrusion or compression moulding.

Advantageously, the articles obtained from the combination or the composition according to the invention have great flexibility and also high chemical inertness.

Advantageously, the articles obtained from the combination according to the invention may be used in the field of the chemical, pharmaceutical or food industry, construction materials, motor vehicles, decoration, electronics, or cable insulation.

### Examples

The inventors studied the elastic and chemical resistance properties of polymers according to the invention.

1. Polymers Used
P1: statistical copolymer of vinylidene fluoride and of hexafluoropropylene having a melt viscosity of 2000 Pa·s at 100 s⁻¹ and 230° C. Hexafluoropropylene is present in an amount of 33% by weight relative to the total weight of the copolymer.
P2: statistical copolymer of vinylidene fluoride and of hexafluoropropylene having a melt viscosity of 2000 Pa·s at 100 s⁻¹ and 230° C. Hexafluoropropylene is present in an amount of 26% by weight relative to the total weight of the copolymer.
P3: thermoplastic polyester polyurethane elastomer, the rigid segment of which is composed of diphenylmethylene 4,4′-diisocyanate/1,4-butanediol and the flexible segment of which is composed of butanediol adipate. The polyester content is 70% by weight relative to the total weight of the thermoplastic elastomer.
P4: thermoplastic polyether polyurethane elastomer, the rigid segment of which is composed of diphenylmethylene 4,4′-diisocyanate/1,4-butanediol and the flexible segment of which is composed of polytetramethylene glycol.
P5: thermoplastic polyester polyamide elastomer, the rigid segment of which is composed of polyamide 12 and the flexible segment of which is composed of polycaprolactone. The polyester content is 77% relative to the total weight of the thermoplastic elastomer.
P6: thermoplastic polyetherester polyamide elastomer, the rigid segment of which is composed of polyamide 12 and the flexible segment of which is composed of polytetramethylene glycol and polycaprolactone blocks. The polyester content is 38% by weight relative to the total weight of the thermoplastic elastomer.
P7: thermoplastic polyetherester polyamide elastomer, the rigid segment of which is composed of polyamide 12 and the flexible segment of which is composed of polytetramethylene glycol.

2. Mixtures

The compositions that were used for this example are presented in table 1 below.

TABLES 1

| | Composition | % |
|---|---|---|
| | (weight %) | ester |
| E1: Comparative Example 1 | 100% P1 | 0% |
| E2: Comparative Example 2 | 100% P2 | 0% |
| E3: Comparative Example 3 | 100% P3 | 70% |
| E4: Comparative Example 4 | 60% P1 + 40% P4 | 0% |
| E5: Comparative Example 5 | 60% P1 + 40% P3 | 28% |
| E6: Comparative Example 6 | 80% P1 + 20% P3 | 14% |
| E7: Composition according to the invention | 60% P1 + 40% P5 | 31% |
| E8: Composition according to the invention | 75% P1 + 25% P5 | 19% |
| E9: Composition according to the invention | 85% P1 + 15% P5 | 12% |
| E10: Composition according to the invention | 50% P1 + 50% P6 | 19% |
| E11: Composition according to the invention | 75% P1 + 25% P6 | 10% |
| E12: Comparative example | 60% P1 + 40% P7 | 0% |
| E13: Comparative example | 100% P5 | 77% |

The mixtures were prepared in a Brabender internal mixer under the following operating conditions:
Temperature: 200° C.
Rotation speed: 100 rpm
Mixing time: 3 minutes after introduction of the constituents

The mixtures were then pressed on a Darragon press to cut out test specimens under the following conditions:
Temperature: 200° C.
Preheating time: 8 min
Pressure maintenance: 2 minutes at 100 bar
Cooling: 5 minutes at 50 bar
Use of Teflon inserts.

3. Tensile Test

The tensile test conditions used are 50 mm/min at 23° C.

4. Chemical Resistance

The test is performed by depositing a drop of coffee on the surface of the test specimens for a period of one week at 23° C. The stain is then wiped with a dry cloth and evaluated visually. A grade from A to C is attributed (A=resistant, B=limited/satisfactory resistance, C=not resistant).

5. Shrinkage

A grade out of three is attributed according to the difference between the nominal dimensions of the moulded sample and its real dimensions after forming: 1=shrinkage of less than 2%; 2=shrinkage of less than 5%; 3=shrinkage of greater than 5%.

6. UV Resistance

A flat sample is exposed for 300 hours in a xenon UV ageing chamber under the following test conditions:
Irradiance=0.51 W/m²/h
Wavelength=340 nm
Chamber temperature=42° C.
Relative humidity=5%

The optical properties are measured before and after ageing using a spectrophotometer in visible light reflectance mode. The difference in optical properties ΔE* is quantified.

A grade out of 3 is attributed: 1: ΔE*<1; 2: 1<ΔE*<2; 3: ΔE*>2.

7. Results

The results are presented in Table 2 below:

TABLES 2

| | Composition | Elongation at | Chemical | | UV |
|---|---|---|---|---|---|
| | (weight %) | break | resistance | Shrinkage | resistance |
| E1 | 100% P1 | >500% | A | 3 | 1 |
| E2 | 100% P2 | >500% | C | 1 | 1 |
| E3 | 100% P3 | >500% | C | 1 | 3 |
| E4 | 60% P1 + 40% P4 | <100% | C | 1 | 3 |
| E5 | 60% P1 + 40% P3 | >500% | B | 1 | 3 |
| E6 | 80% P1 + 20% P3 | >500% | B | 2 | 2 |
| E7 | 60% P1 + 40% P5 | >500% | B | 1 | 1 |
| E8 | 75% P1 + 25% P5 | >500% | B | 1 | 1 |
| E9 | 85% P1 + 15% P5 | >500% | B | 2 | 1 |
| E10 | 50% P1 + 50% P6 | >500% | B | 1 | 1 |
| E11 | 75% P1 + 25% P6 | >500% | B | 2 | 1 |
| E12 | 60% P1 + 40% P7 | <100% | C | 1 | 1 |
| E13 | 100% P5 | >500% | C | 1 | 2 |

The compositions obtained according to the invention have both great resistance to elongation associated with chemical resistance and resistance to UV radiation and also low shrinkage during the forming of the product.

1. A combination of polymers comprising:
at least one thermoplastic elastomer comprising at least 10% by mass of ester flexible blocks relative to the total mass of the thermoplastic elastomer, and
at least one fluoropolymer comprising a vinylidene fluoride homopolymer or copolymer,
wherein the thermoplastic elastomer is selected from the group consisting of copolyester elastomers (TPEE) and polyester-based polyamide elastomers (TPE-A).

2. The combination of claim 1, in which the thermoplastic elastomer comprises at least 15% by mass of ester flexible blocks relative to the total mass of the thermoplastic elastomer.

3. The combination of claim 1, comprising between 50% and 90% by mass of fluoropolymer relative to the total mass of the combination.

4. The combination of claim 1, comprising between 60% and 80% by mass of fluoropolymer relative to the total mass of the combination.

5. The combination of claim 1, wherein the thermoplastic elastomer comprises polyester flexible blocks.

6. The combination of claim 5, wherein the polyester flexible blocks are selected from the group consisting of polybutyl adipate, polyglycol sebacate, poly(caprolactone) and polyesters based on fatty acid dimers.

7. The combination of claim 1, wherein the thermoplastic elastomer comprises rigid blocks are selected from polyamide segments, styrene segments and ester segments.

8. The combination of claim 1, wherein the thermoplastic elastomer is a polyester polyamide.

9. The combination of claim 1, wherein the fluoropolymer is a vinylidene fluoride homopolymer or a copolymer prepared by copolymerization of vinylidene fluoride with a fluoro comonomer chosen from: vinyl fluoride; trifluoroethylene (VF3); chlorotrifluoroethylene (CTFE); 1,2-difluoroethylene; tetrafluoroethylene (TFE); hexafluoropropylene (HFP); perfluoro(alkyl vinyl) ethers, perfluoro(1,3-dioxole); and perfluoro(2,2-dimethyl-1,3-dioxole) (PDD).

10. The combination of claim 1, wherein the fluoropolymer comprises an amount of vinylidene fluoride, in the copolymer, of greater than 50% by mass relative to the total mass of the fluoropolymer.

11. The combination of claim 1, wherein the thermoplastic elastomer and the fluoropolymer have been mixed in molten form.

12. The combination of claim 1, comprising at least one bilayer formed from a layer of the fluoropolymer on a layer of the thermoplastic elastomer.

13. A composition comprising the combination of claim 1.

14. An article formed from the combination of a claim 1.
